(19) United States
(12) Patent Application Publication
(10) Pub. No.: US 2019/0337679 A1
(43) Pub. Date: Nov. 7, 2019

(54) EASY OPEN DISPOSABLE BAG

(71) Applicant: Rolanda Gontz, Pittsburgh, PA (US)

(72) Inventor: Rolanda Gontz, Pittsburgh, PA (US)

(21) Appl. No.: 15/969,704

(22) Filed: May 2, 2018

(51) Int. Cl. B65D 33/00

(52) U.S. Cl. CPC B65D 33/007; B65F 1/0006; B65D 33/002

(57) ABSTRACT

A disposable bag; the disposable bag includes a bag-body, a first grip-patch and a second grip-patch. The first grip-patch and the second grip-patch are adhesively attached to opposite external sides of the bag-body. Simultaneous gripping of the first grip-patch and the second grip-patch provides a friction configured to allow for improved separation of the external sides of the bag-body, such that the user is able to quickly access an inner-capacity of the bag for use. In a preferred embodiment, the disposable bag is a pet waste disposal bag. In some embodiments, the disposal bag may be part of a roll of disposable bags.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of disposable bags and more specifically relates to a disposable bag including easy open grip patches.

### 2. DESCRIPTION OF RELATED ART

Plastic bags, especially those produced on a roll, can be very difficult to open. The smooth, slippery texture of the bags makes it hard for users to easily open the bag. Pet owners often use plastic waste bags to dispose of pet waste. When out walking their dog, many individuals only have the use of one hand. It can be a tedious and time-consuming process to try and open the bag to dispose of the waste. An effective alternative is needed.

U.S. Pat. No. 8,550,716 to Leland J. Smith relates to a tactile enhancement mechanism for a closure mechanism. The described tactile enhancement mechanism for a closure mechanism includes a pouch including opposing sidewalls sealed together in a closed distal portion to form an interior that is accessible by a proximal opening. A closure profile extends along an interior surface of the opposing sidewalls for selectively sealing the proximal opening, wherein the closure profile substantially extends a length of the proximal opening. A plurality of tactile strips are disposed on an interior surface of at least one of the opposing sidewalls between the closure profile and the proximal opening, the tactile strips being variably spaced. Preferably, each tactile strip has a well-formed triangular cross-sectional shape with a height from the respective sidewall approximately double a thickness of the respective sidewall.

### BRIEF SUMMARY OF THE INVENTION

In view of the foregoing disadvantages inherent in the known disposable bags art, the present disclosure provides a novel easy open disposable bag. The general purpose of the present disclosure, which will be described subsequently in greater detail, is to provide a disposable bag with grip patches for allowing easier opening of the bag.

A disposable bag is disclosed herein. The disposable bag includes a bag-body which may include a first-layer attached to a second-layer via a bottom-edge, a first side-edge and a second side-edge and defining an inner-capacity therein. The first-layer may include a first interior-surface, a first exterior-surface opposite the first interior-surface and a first top-edge. Similarly, the second-layer may include a second interior-surface, a second exterior-surface opposite the second interior-surface and a second top-edge. The first top-edge and the second top-edge may define an opening, and the inner-capacity may be accessible via the opening (when opened).

A first grip-patch may be attached to the first exterior-surface about the first top-edge via an adhesive. The first grip-patch may include a textured-material configured to provide grip-ability to a user. Likewise, a second grip-patch may be attached to the second exterior-surface about the second top-edge via the adhesive and may include the textured-material configured to provide the grip-ability to the user.

A method of using the disposable bag is also disclosed herein. The method of using disposable bag may comprise the steps of: providing the disposable bag as above; placing a first digit of the user on the first grip-patch; placing a second digit of the user on the second grip-patch; simultaneously gripping the first grip-patch and the second grip-patch; opening the first top-edge and the second top-edge to access the inner-capacity; and using the disposable bag.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an easy open disposable bag, constructed and operative according to the teachings of the present disclosure.

FIG. 1 is a side perspective view of the disposable bag during an ‘in-use’ condition, according to an embodiment of the disclosure.

FIG. 2 is a side perspective view of the disposable bag of FIG. 1, according to an embodiment of the present disclosure.

FIG. 3 is a side and front perspective view of the disposable bag of FIG. 1, according to an embodiment of the present disclosure.

FIG. 4 is a side-front perspective view of the disposable bag of FIG. 1, according to an embodiment of the present disclosure.

FIG. 5 is a flow diagram illustrating a method of use for the disposable bag, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to disposable bags and more particularly to an easy open disposable bag as used to improve the use of disposable bags by including easy open grip patches.

Generally, disclosed is a friction patch which may attach to a side of a plastic bag to enable users to easily open the bag. Further, this may enable bags on a roll to be quickly separated and opened for use. In particular, the disposable bag may be a dog waste bag. In this embodiment, dog owners and dog walkers may easily open a plastic bag to dispose of pet waste. The bag may allow users the ability to open a plastic bag using one hand.

The friction patch may include a thin layer of adhesive/textured material attached to either side of a plastic bag. The size of the adhesive/textured material may vary depending on the size of the bag. As above, the adhesive/textured material may be particularly useful when applied to plastic bags packaged on a roll, such as those used to dispose of pet waste. However, this concept may be applied to various other types of plastic bags, such as garbage bags. Users may be able to place their thumb or finger on textured patch in order to separate the top portion of the bag. The exact specifications may vary.

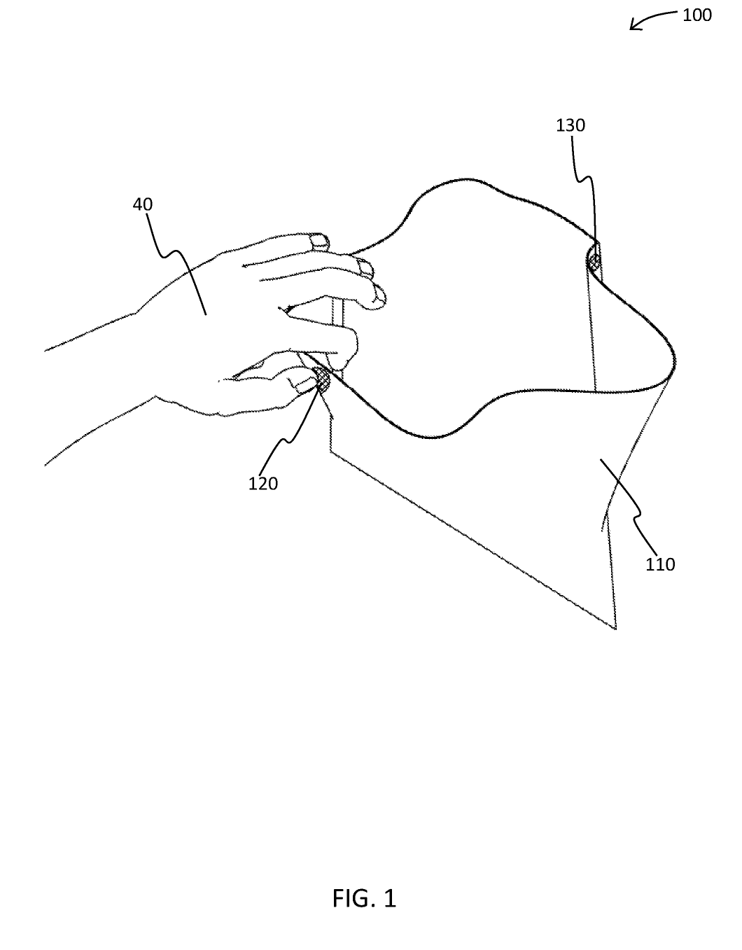

Referring now more specifically to the drawings by numerals of reference, there is shown in FIGS. 1-4, various views of a disposable bag 100. FIG. 1 shows a disposable bag 100 during an ‘in-use’ condition 150, according to an embodiment of the present disclosure. As illustrated, the disposable bag 100 may include a bag-body 110, a first grip-patch 120 and a second grip-patch 130.

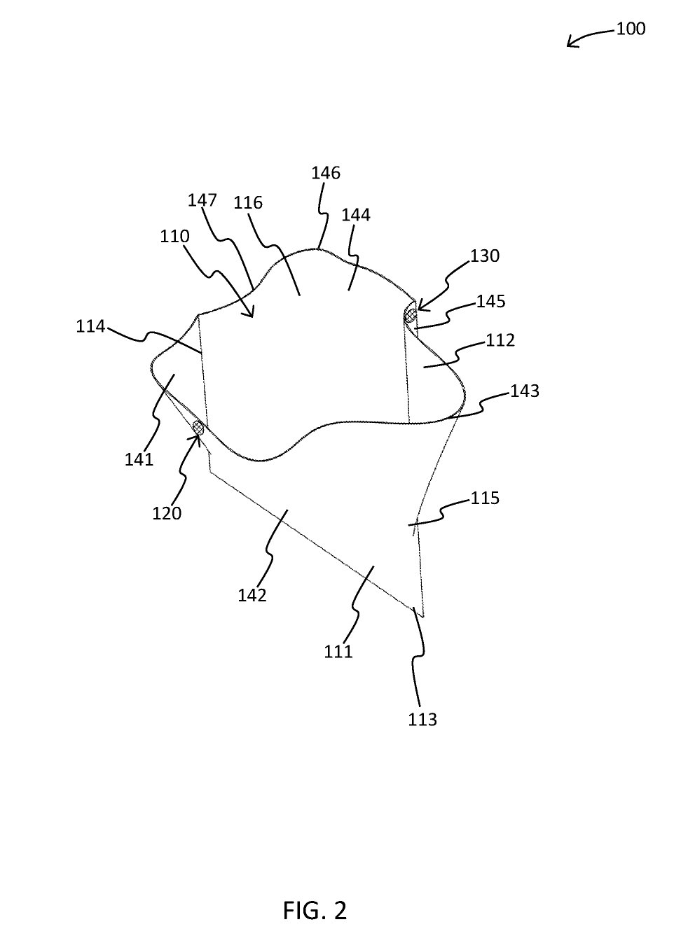

FIG. 2 shows a side perspective view of the disposable bag 100 of FIG. 1, according to an embodiment of the present disclosure. The bag-body 110 may include a first-layer 111 attached to a second-layer 112 via a bottom-edge 113, a first side-edge 114 and a second side-edge 115 and defining an inner-capacity 116 therein. The first-layer 111 may include a first interior-surface 141, a first exterior-surface 142 opposite the first interior-surface 141 and a first top-edge 143. Similarly, the second-layer 112 may include a second interior-surface 144, a second exterior-surface 145 opposite the second interior-surface 144 and a second top-edge 146. The first top-edge 143 and the second top-edge 146 may define an opening 147 and the inner-capacity 116 may be accessible via the opening 147. In a preferred embodiment, simultaneous gripping of the first grip-patch 120 and the second grip-patch 130 may provide a friction configured to allow for improved separation of the first top-edge 143 and the second top-edge 146, such that the user is able to quickly access the inner-capacity 116 via the opening 147.

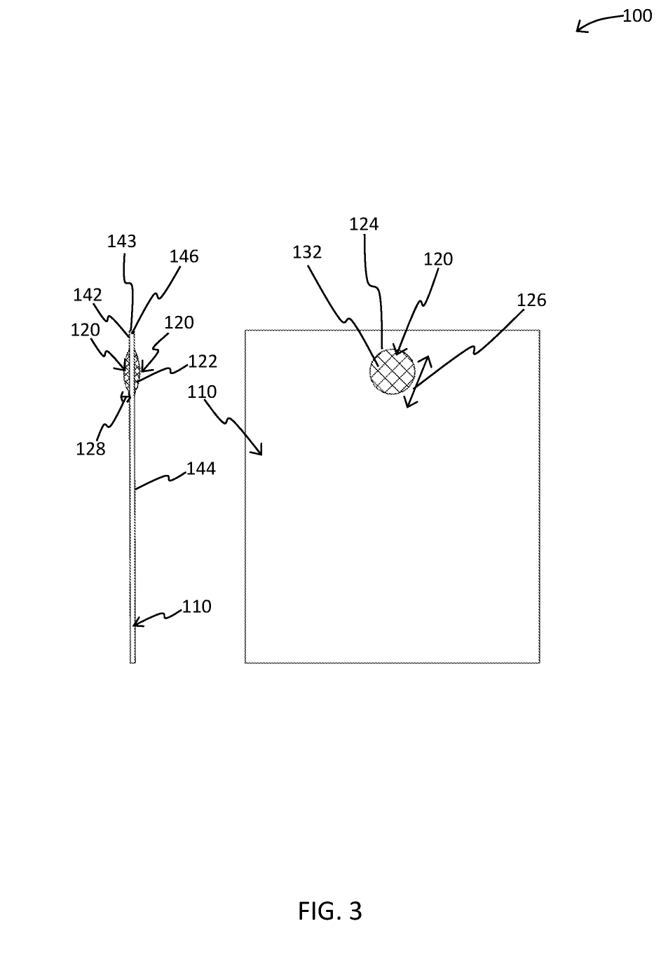

Referring now to FIG. 3 showing side and front perspective views of the disposable bag 100 of FIG. 1, according to an embodiment of the present disclosure. The first grip-patch 120 may be attached to the first exterior-surface 142 about the first top-edge 143 via an adhesive 122 and may include a textured-material 124 configured to provide grip-ability to a user. Likewise, a second grip-patch 130 may be attached to the second exterior-surface 145 about the second top-edge 146 via the adhesive 122 and include the textured-material 124 configured to provide the grip-ability to the user. In a preferred embodiment, the adhesive 122 may be glue. Use of heat may also be used to cause desired surfaces to adhere to one another. In one embodiment, the adhesive 122 may be permanent; in this embodiment the first grip-patch 120 and the second grip-patch 130 may be configured for permanent attachment to the first exterior-surface 142 and the second exterior-surface 145, respectively. In other embodiments, the adhesive 122 may be non-permanent, and in these embodiments, the first grip-patch 120 and the second grip-patch 130 may be configured for removable attachment to the first exterior-surface 142 and the second exterior-surface 145, respectively.

In the preferred embodiment, the first grip-patch 120 and the second grip-patch 130 may be circular in shape. However, other shapes may be used. In the circular embodiment, the first grip-patch 120 and the second grip-patch 130 may include a patch-diameter 126 substantially equal to a finger-diameter of a pad of a finger of the user. Further, the first grip-patch 120 and the second grip-patch 130 include the patch-diameter 126 substantially equal to a thumb-diameter of a pad of a thumb of the user. This may allow the user to be able to have better grip on the first grip-patch 120 and the second grip-patch 130 to aid in opening 147 of the bag-body 110.

In addition to this, the first grip-patch 120 and the second grip-patch 130 each include a thickness 128 of at least 1 mm. This thickness 128 may create an obvious and feel-able difference between the bag-body 110 and the first grip-patch 120 and the second grip-patch 130, such that the user may be able to quickly grip the first grip-patch 120 and the second grip-patch 130 without looking. To aid in this, the textured-material 124 may comprise a raised-pattern 132. In the preferred embodiment, the raised-pattern 132 may be a crosshatch pattern, however other raised-patterns 132 are envisioned. Further, in the preferred embodiment the textured-material 124 may be rubber or silicone. However, other materials are contemplated such as fabrics, plastics, etc.

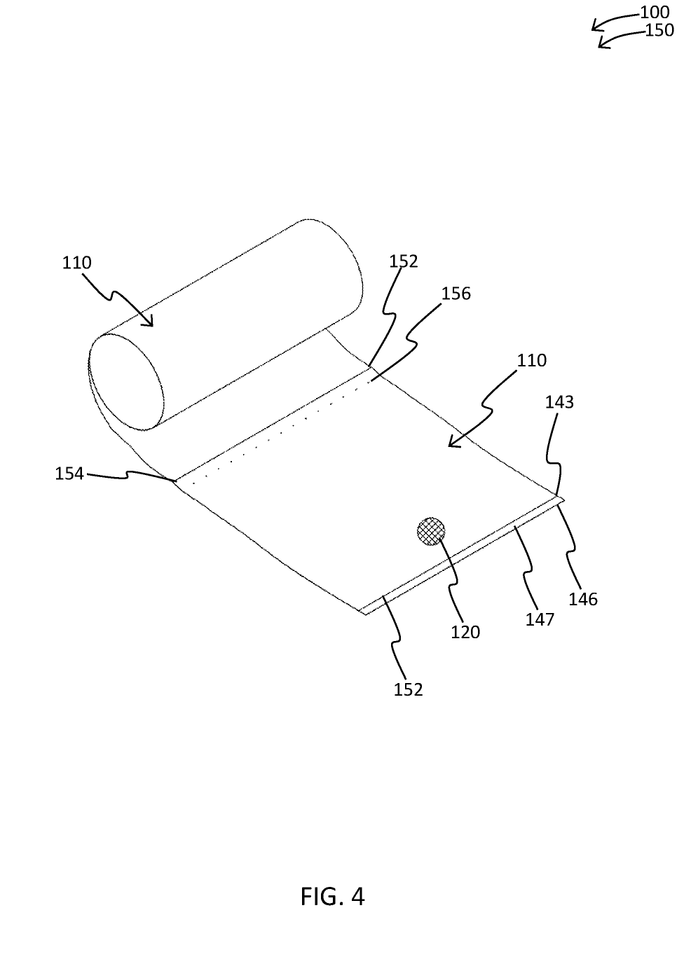

FIG. 4 shows a side-front perspective view of the disposable bag 100 of FIG. 1, according to an embodiment of the present disclosure. In the preferred embodiment, the disposable bag 100 may be made of plastic. In some embodiments, the disposable bag 100 may be a pet waste disposal bag. In other embodiments, the disposable bag 100 may be a trash liner bag. Other types of disposable bag(s) 100 are also contemplated.

As shown in this figure, the disposable bag 100 may be a part of a roll of disposable bags 150. In this embodiment, the roll of disposable bags 150 may include a plurality of disposable bags 100, each of the plurality of the disposable bags 100 including a top-end 152 and a bottom-end 154 opposite the top-end 152, the top-end 152 including a first top-edge 143 and a second top-edge 146 defining an opening 147 for access into an inner-capacity 116, the top-end 152 of each one of the plurality of disposable bag 100s being removably attached to the bottom-end 154 of another one of the plurality of disposable bags 100 via a perforated line 156. As shown, each of the disposable bags 100 may include the elements as above: the bag-body 110, the first grip-patch 120 and the second grip-patch 130.

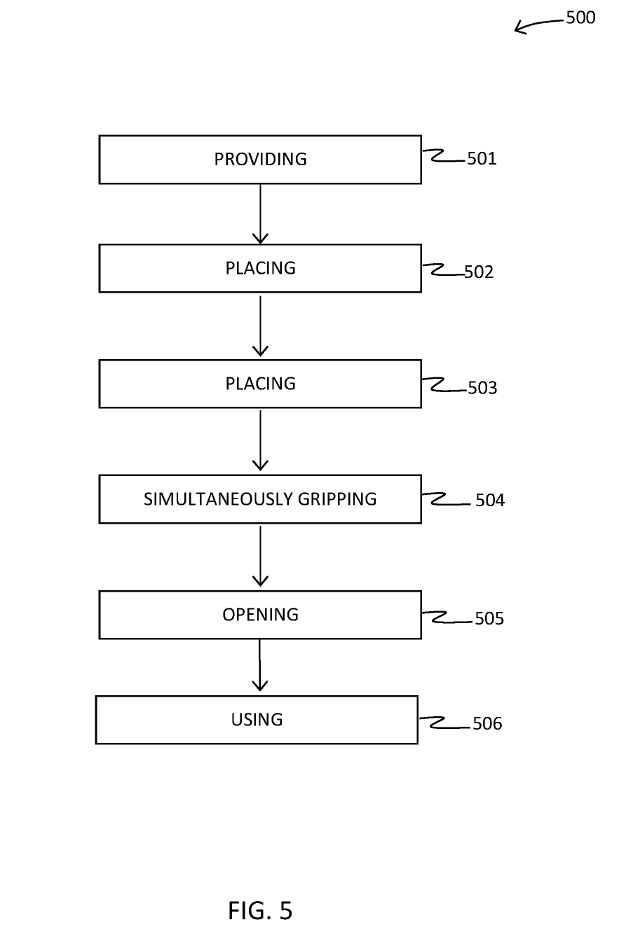

Referring now to FIG. 5 showing a flow diagram illustrating a method of using 500 a disposable bag 100, according to an embodiment of the present disclosure. As illustrated, the method of using 500 a disposable bag 100 may include the steps of: step one 501, providing the disposable bag 100 as above; step two 502, placing a first digit of the user on the first grip-patch 120; step three 503, placing a second digit of the user on the second grip-patch 130; step four 504, simultaneously gripping the first grip-patch 120 and the second grip-patch 130; step five 505, opening 147 the first top-edge 143 and the second top-edge 146 to access the inner-capacity 116; and step six 506, using the disposable bag 100. In the preferred embodiment, the first digit of the user may be a finger, and the second digit of the user may be the thumb.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for disposable bag 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A disposable bag comprising:
a bag-body including a first-layer attached to a second-layer via a bottom-edge, a first side-edge and a second side-edge and defining an inner-capacity therein, the first-layer including a first interior-surface, a first exterior-surface opposite the first interior-surface and a first top-edge, the second-layer including a second interior-surface, a second exterior-surface opposite the second interior-surface and a second top-edge, the first top-edge and the second top-edge defining an opening, and wherein the inner-capacity is accessible via the opening;
a first grip-patch attached to the first exterior-surface about the first top-edge via an adhesive, the first grip-patch including a textured-material configured to provide grip-ability to a user; and
a second grip-patch attached to the second exterior-surface about the second top-edge via the adhesive, the second grip-patch including the textured-material configured to provide the grip-ability to the user; and
wherein simultaneous gripping of the first grip-patch and the second grip-patch provides a friction configured to allow for improved separation of the first top-edge and the second top-edge, such that the user is able to quickly access the inner-capacity via the opening.

2. The disposable bag of claim 1, wherein the first grip-patch and the second grip-patch are circular in shape.

3. The disposable bag of claim 2, wherein the first grip-patch and the second grip-patch include a patch-diameter substantially equal to a finger-diameter of a pad of a finger of the user.

4. The disposable bag of claim 2, wherein the first grip-patch and the second grip-patch include the patch-diameter substantially equal to a thumb-diameter of a pad of a thumb of the user.

5. The disposable bag of claim 4, wherein the first grip-patch and the second grip-patch each include a thickness of at least 1 mm.

6. The disposable bag of claim 1, wherein the textured-material is rubber.

7. The disposable bag of claim 1, wherein the textured-material is silicone.

8. The disposable bag of claim 1, wherein the textured-material is fabric.

9. The disposable bag of claim 1, wherein the textured-material comprises a raised-pattern.

10. The disposable bag of claim 9, wherein the raised-pattern is a crosshatch pattern.

11. The disposable bag of claim 1, wherein the disposable bag is a pet waste disposal bag.

12. The disposable bag of claim 1, wherein the disposable bag is a trash liner bag.

13. The disposable bag of claim 1, wherein the disposable bag is made of plastic.

14. The disposable bag of claim 1, wherein the adhesive is glue.

15. The disposable bag of claim 1, wherein the first grip-patch and the second grip-patch are configured for permanent attachment to the first exterior-surface and the second exterior-surface, respectively.

16. The disposable bag of claim 1, wherein the first grip-patch and the second grip-patch are configured for removable attachment to the first exterior-surface and the second exterior-surface, respectively.

17. A roll of disposable bags including:
a plurality of disposable bags, each of the plurality of the disposable bags including a top-end and a bottom-end opposite the top-end, the top-end including a first top-edge and a second top-edge defining an opening for access into an inner-capacity, the top-end of each one of the plurality of disposable bags being removably attached to the bottom-end of another one of the plurality of disposable bags via a perforated line, each of the plurality of disposable bags further including:
a bag-body including a first-layer attached to a second-layer via a bottom-edge, a first side-edge and a second side-edge and defining the inner-capacity therein, the first-layer including a first interior-surface, a first exterior-surface opposite the first interior-surface and the first top-edge, the second-layer including a second interior-surface, a second exterior-surface opposite the second interior-surface and the second top-edge;
a first grip-patch attached to the first exterior-surface about the first top-edge via an adhesive, the first grip-patch including a textured-material configured to provide grip-ability to a user; and
a second grip-patch attached to the second exterior-surface about the second top-edge via the adhesive, the second grip-patch including the textured-material configured to provide the grip-ability to the user; and
wherein simultaneous gripping of the first grip-patch and the second grip-patch provides a friction configured to allow for improved separation of the first top-edge and the second top-edge, such that the user is able to quickly access the inner-capacity via the opening.

18. A method of using a disposable bag, the method comprising the steps of:
providing the disposable bag, the disposable bag including:
a bag-body including a first-layer attached to a second-layer via a bottom-edge, a first side-edge and a second side-edge and defining an inner-capacity therein, the first-layer including a first interior-surface, a first exterior-surface opposite the first interior-surface and a first top-edge, the second-layer including a second interior-surface, a second exterior-surface opposite the second interior-surface and a second top-edge, the first top-edge and the second top-edge defining an opening, and wherein the inner-capacity is accessible via the opening;
a first grip-patch attached to the first exterior-surface about the first top-edge via an adhesive, the first grip-patch including a textured-material configured to provide grip-ability to a users' fingers; and
a second grip-patch attached to the second exterior-surface about the second top-edge via the adhesive, the second grip-patch including the textured-material configured to provide the grip-ability to the users' fingers; and
wherein simultaneous gripping of the first grip-patch and the second grip-patch provides a friction configured to allow for improved separation of the first top-edge and the second top-edge, such that the user is able to quickly access the inner-capacity via the opening;
placing a first digit of the user on the first grip-patch;
placing a second digit of the user on the second grip-patch;
simultaneously gripping the first grip-patch and the second grip-patch;
opening the first top-edge and the second top-edge to access the inner-capacity; and
using the disposable bag.

19. The method of claim 18, wherein the first digit of the user is a finger.

20. The method of claim 19, wherein the second digit of the user is a thumb.
